(19) United States
(12) Patent Application Publication
(10) Pub. No.: US 2024/0280442 A1
(43) Pub. Date: Aug. 22, 2024

(54) DIE TEST/INSPECTION APPARATUS

(71) Applicant: CORRADA S.P.A., Lainate (MI) (IT)

(72) Inventor: Alberto Curatoli, Rho (MI) (IT)

(21) Appl. No.: 18/569,024

(22) PCT Filed: Jun. 14, 2022
(86) PCT No.: PCT/IB2022/055493

§ 371 Date: Dec. 11, 2023

(30) Foreign Application Priority Data
Jun. 17, 2021 (IT) 102021000015893

(51) Int. Cl. G01M 99/00; B21D 28/14; B21D 28/26; B21D 37/10

(52) U.S. Cl. CPC G01M 99/008; B21D 28/14; B21D 28/26; B21D 37/10

(57) ABSTRACT

A test/inspection apparatus (10) for dies for electrical use, in particular for dies for cutting magnetic metal plates adapted to be stacked or superimposed one on the other to define layered packs for use in electrical machines, comprising interaction means with special functions (20) or mechanical elements of a cutting die (21), which enable/disable one or more cutting elements of said die, said apparatus being coupled to the cutting die (21) for testing it off a cutting press.

The present invention relates to a test/inspection apparatus for dies.

More in detail, the present invention relates to a test/inspection apparatus for dies for electrical use and, specifically, for cutting dies of magnetic metal plates adapted to be packed or superimposed on one another to define layered packs for use in electrical machines, such as motors, generators, transformers, meters, ignition coils and similar electric equipment.

As known, the magnetic metal plates needed for forming layered packs are obtained by starting from a metal sheet subjected to cutting operations by means of dedicated dies which, for the purpose, comprise elements named “special functions” in the industry, i.e., mechanical elements of a die, activated either manually or by a pneumatic or hydraulic piston, which enable/disable one or more cutting elements of a die.

An example of a “special function” is a type of metal plate stacking made in progressive dies, in which the metal plates, which are stacked on top of one another, are each provided with protruding claws, which define a recess at the opposite surface (with respect to the surface of the claw) and with the claw of a metal plate being constrained in the recess of the adjacent metal plate, and with a further metal plate, which is interposed between two adjacent and mutually constrained metal plates and which is provided with a through opening adapted to be crossed by the claw of a metal plate, which couples with the recess of the adjacent metal plate; in this case, the special function is activated and deactivated with each press stroke.

Furthermore, there may be a plurality of “special functions” in a progressive type die, such as for example the one described above for the specific stacking solution, and it is possible to activate/deactivate the cutting dies by activating/deactivating said functions to obtain cut products (e.g., the metal plates) with multiple geometries or shapes.

However, said “special functions” have some drawbacks in that they are activated/deactivated during the production cycle of the metal plates and layered pack.

Typically, the die is tested directly on the cutting press, and the “special functions” are also tested together with the die; consequently, any malfunctions of the die or the “special functions” or any breakage or the like occur directly on the cutting press, which, if such incidents occur, must be stopped.

As a result of this, there is an increase in maintenance-related costs, because breakages or malfunctions occur directly on the press, and, furthermore, there is an increase in production costs caused by machine downtime.

It is the object of the present invention to obviate the drawbacks disclosed above.

More in particular, it is an object of the present invention to provide a die test/inspection apparatus and, even more in particular, a test/inspection apparatus for the so-called “special functions” of dies for cutting magnetic metal plates adapted to be packed or superimposed on one another to define layered packs.

It is a further object of the present invention to provide a test/inspection apparatus which allows testing the special functions of a die on the bench rather than on the press (as is traditionally done).

It is a further object of the present invention to provide a apparatus adapted to allows testing critical test components which are part of the “special function” of the die on a bench.

It is a further purpose of the present invention to provide a test apparatus adapted to allow the performance of stress tests, i.e., fatigue and/or wear tests with respect to the “special functions” of the die to be able to predict its behavior during the production and working phases of the press in which the die is installed.

It is a further object of the present invention to make available to users a die test/inspection apparatus adapted to guarantee high strength and reliability over time and, furthermore, such to be made easily and cost-effectively.

These and other objects are achieved by the invention having the features outlined in claim 1.

According to the invention, a test/inspection apparatus for dies for electrical use is provided, in particular for dies for cutting magnetic metal plates adapted to be stacked or superimposed on one another to define layered packs for use in electric machines, comprising interaction means with special functions or the mechanical elements of a cutting die, which enable/disable one or more cutting elements of said die, said apparatus coupled to the cutting die for testing it off a cutting press.

Advantageous embodiments of the invention appear from the dependent claims.

The constructional and functional features of the test/inspection apparatus for dies according to the present invention may be better understood from the detailed description which follows in which reference is made to the appended drawings which illustrate a preferred and non-limiting embodiment thereof and in which:

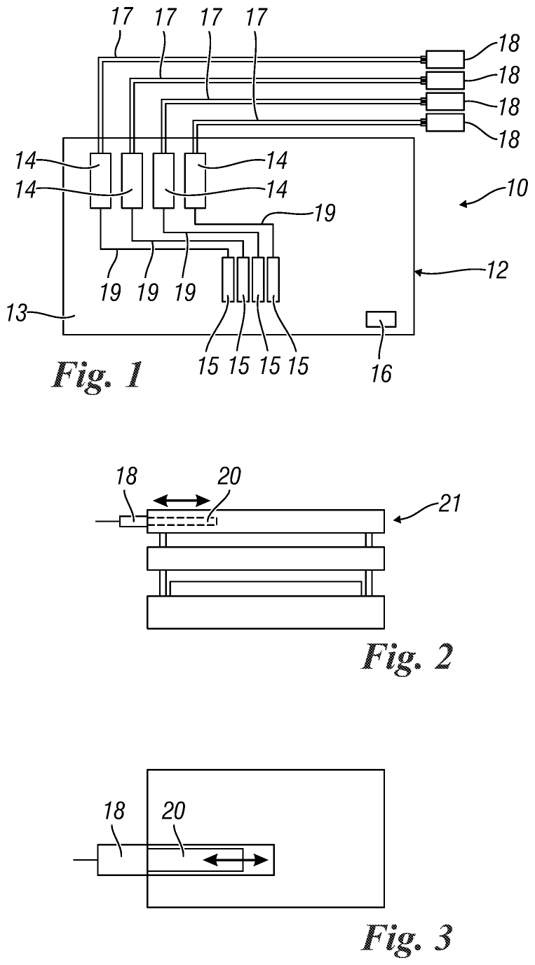

FIG. 1 diagrammatically shows an element of the die test/inspection apparatus of the present invention;

FIG. 2 diagrammatically shows a cutting die to which the test/inspection apparatus of the invention is coupled;

FIG. 3 diagrammatically shows the activation of a “special function”.

With reference to the above figures, the die testing/inspection apparatus of the present invention, indicated by reference numeral 10 as a whole in the figures, is defined by a device 12, which comprises a box-like body 13 inside which the functional components for the operation of the apparatus are arranged, which comprise one or more solenoid valves 14, one or more timing devices 15 connected to said one or more solenoid valves 14, and a power supply 16 for supplying said at least one solenoid valve 14 and at least one timing device 15.

The at least one solenoid valve 14 is connected to the at least one actuator 18 by means of compressed air pipes 17 and to the at least one timer 15 by means of cables 19.

The at least one actuator 18 is preferably defined by a double-acting piston, typically of pneumatic type and is directly connected to a “special function” 20 of a cutting die 21.

The single solenoid valve 14 controls the opening and closing of a compressed air circuit to activate/deactivate the actuation of at least one actuator 18.

The function the at of least one timer 15 is to enable/disable the at least one solenoid valve 14 and, consequently, enable/disable the operation of the at least one actuator 18.

More in particular, the timer 15 sends an on/off type electrical pulse to the solenoid valve 14, which, in turn, controls the activation/deactivation of the actuator 18; the current pulse of the timer is adjustable over time by adjusting the number of pulses per minute according to the specific testing requirements of the “special functions”.

The solenoid valve 14 opens and closes the compressed air circuit according to the number and sequence of pulses selected by the timer 15, so that the actuator is activated and deactivated synchronized with the number of pulses selected by the same timer, with said actuator activating and deactivating the special function 20 of the cutting die 21 according to said pulses.

The number of timers 15 is functional to the number of solenoid valves 14, the number of which, in turn, corresponds to the number of actuators 18, which correspond to the number of special functions to be tested.

The advantages that the test/inspection apparatus for dies of the present invention achieves are apparent from the foregoing description.

The die test/inspection apparatus of the present invention advantageously allows the special functions of a die to be tested on the bench, i.e., off the cutting press, with a considerable and important reduction in testing time; in particular, the apparatus of the invention allows the mechanical components, which are part of a special function of a die, to be tested on the bench and, thereby, reduces the probability of breakage of the special function being processed and, consequently, reduces the number of tests (which has repercussion on costs).

A further advantage of the apparatus of the invention is that it allows “predicting” some critical components that are part of the special function; indeed, the apparatus of the invention allows performing mechanical tests on the special functions of a die which, being movable components, are more subject to wear and fatigue, and by means of the testing apparatus, it is possible to predict the criticalities to which the die might be subjected in the course of production procedures.

Further advantageous is that the test/inspection apparatus of the invention allows the performance of stress tests or fatigue or wear tests of the special functions of a die to predict the production behavior of the die; indeed, by means of the at least one timer, it is possible to select the desired number of pulses per minute while also simulating possible speed conditions as well as cutting conditions.

Although the invention has been described above with particular reference to an embodiment thereof, given by way of non-limiting embodiment, many modifications and variations will be apparent to a person skilled in the art in light the above description. Therefore, the present invention aims to encompass all modifications and variants falling within the scope of the following claims.

1. A test/inspection apparatus (10) for dies for electrical use, in particular for dies for cutting magnetic metal plates adapted to be packed or superimposed on top of one another to define layered packs for use in electric machines, said test/inspection apparatus being coupled to a cutting die (21) on the bench for testing/inspecting off a cutting press special functions (20) or mechanical elements of a cutting die (21) which enable/disable one or more cutting elements of said die, characterized in that it comprises a device (12), which comprises a box-like body (13), in which one or more solenoid valves (14) are arranged for enabling/disabling the actuation of one or more actuators (18) coupled directly to a special functions (20) or mechanical elements of a cutting die (21), one or more timing devices (15) connected to said one or more solenoid valves (14) for activating/deactivating them, and a power supply (16) for supplying power to said at least one solenoid valve (14) and said at least one timer (15).

2. The apparatus according to claim 1, characterized in that the actuators (18) comprise a double-acting piston.

3. The apparatus according to claim 2, characterized in that the pistons are of the pneumatic type.

4. The apparatus according to claim 1, characterized in that the at least one solenoid valve (14) is connected to at least one actuator (18) by means of compressed air pipes (17) and is connected to the at least one timer (15) by means of cables (19).

5. The apparatus according to claim 4, characterized in that the solenoid valve (14) opens and closes the compressed air circuit as a function of the number and sequence of pulses selected by the timer (15) for an activation/deactivation of the actuator (18) synchronized with the number of pulses selected by the timer itself.

6. The apparatus according to claim 4, characterized in that the at least one timer (15) activates/deactivates the at least one solenoid valve (14) by means of an electrical pulse of on/off type to the solenoid valve (14), said current pulse being adjustable in time by adjusting the number of pulses per minute.

7. The apparatus according to claim 4, characterized in that the number of timers (15) is functional to the number of solenoid valves (14), which corresponds to the number of actuators 18 which is corresponding to the number of special functions (20) or mechanical elements of a cutting die to be tested.
